(19) United States
(12) Patent Application Publication
(10) Pub. No.: US 2013/0155277 A1
(43) Pub. Date: Jun. 20, 2013

(54) APPARATUS FOR IMAGE DATA RECORDING AND REPRODUCING, AND METHOD THEREOF

(71) Applicant: Ruiz Rodriguez Ezequiel, Panama (PA)

(72) Inventor: Ruiz Rodriguez Ezequiel, Panama (PA)

(21) Appl. No.: 13/700,922

(22) PCT Filed: Jun. 2, 2010
(86) PCT No.: PCT/EP10/57747

§ 371 Date: Feb. 25, 2013

(51) Int. Cl. H04N 9/79

(52) U.S. Cl. CPC H04N 9/79
USPC 348/231.3

(57) ABSTRACT

The present invention relates to an apparatus for image data recording and reproducing. The apparatus includes: an imaging system for capturing an image; a signal processor coupled to the imaging system for processing the captured image as a digital image file; an audio system coupled to the signal processor for acquiring at least one speech annotation apt to be associated with the digital image file; and a speech recognition unit for recognizing the at least one speech annotation and converting the speech annotation into text data, the speech recognition unit being associated to the signal processor for generating metadata using the text data and adding the generated metadata to the digital image file. The speech recognition unit includes a plurality of subsets of words, each subset having a limited number of words, in order to recognize and convert into text speech annotations acquired from a corresponding plurality of languages.

The present application claims priority from PCT Patent Application No. PCT/EP2010/057747 filed on Jun. 2, 2010, the disclosure of which is incorporated herein by reference in its entirety.

### 1. FIELD OF THE INVENTION

The present invention also relates to a method for image data recording and reproducing, in particular for automatically creating metadata for digital image file.

It is noted that citation or identification of any document in this application is not an admission that such document is available as prior art to the present invention.

Apparatuses and methods for image data recording and reproducing are well known at the state of the art; in particular, said apparatuses comprise digital cameras apt to capture images and store them on a digital medium. It should be noted that, in the present text, the words “apparatus” and/or “camera” can be used in order to relate to digital still cameras, digital video cameras, mobile telephones having integrated digital cameras, and the like.

With the apparatuses known at the state of the art, between the time an image is captured and the time it is printed or otherwise displayed, the user (that usually is also the photographer) may forget or lose access to information related to the image, such as the time at which it was captured and/or the location in which it was captured and/or the persons depicted in it.

Some digital cameras allow text, such as text representing the date and the time on which an image was captured, to be associated with a photograph; this text is typically created by the camera and superimposed on the image at a predetermined location and in a predetermined format.

Said text only contains a small amount of information, and it conveys little or no useful information to the user of the digital camera that will help him for distinguishing one image from another.

The same problem arise with the default file naming scheme, that is used in digital cameras in order to identify and track digital image files; in fact, said default file naming scheme only employs:
a combination of letters (for example: “DSC”, “IMG”, “PICT”, “DSCN”, etc.) for indicating the type of digital image file,
a sequence number (for example: “001”, “002”, etc.) appended to said indicator to identify a digital image from another, and
a file type extension (for example, “.TIF”, “.JPG”, etc.) appended after the sequence number in order to identify the type of the file.

Therefore, also with the default file naming scheme the user has little or no useful information about the contents of a particular image file. In fact, the user must open and view each image file to determine if said image file contains a desired image of a person, of a place, and so on. Eventually the user can edit the naming scheme with the help of a computer, but this possibility is practically of no use when done some time after having recorded the images.

Document No. EP1876596 relates to an apparatus for image data recording and reproducing, said apparatus comprising:
a signal processor for capturing images, processing the captured images to generate image data, and generating an image file comprising the image data;
a speech recognition unit for recognizing speech and converting the speech into text data; and
a controller for generating metadata using the text data and adding the generated metadata to the image file.

According to what is described in document No. EP1876596, the metadata to be included in the image file are generated by using the text data converted by the speech recognition unit, so that it is possible to add reliable metadata (such as, for example, shooting locations or persons being displayed in the image) to the image file just after the capture of the image and/or while reviewing the image file.

In addition, the name of the folder in which the image file is to be stored is generated based on the text data that is converted by using speech recognition, so that it is possible to classify the image files at a time when the image is captured.

However, it has been observed that even the apparatus described in document No. EP1876596 suffers from some drawbacks, since it is adapted to recognize and convert only one predetermined language.

In fact, the programs and software for recognizing speech and converting the speech into text data are expensive, large and very big in size, usually in the order of many megabyte (or a gigabyte) for each language that has to be recognized and converted into text; therefore, said programs and software cannot be utilized in a image data recording and reproducing apparatus without making a choice of only one predetermined language for each apparatus.

This implies that each apparatus realized in accordance with the teachings of the document No. EP1876596 needs to comprise a program apt to recognize and convert into text only one language.

This necessarily means that the apparatus cannot be versatile and eclectic, since it is necessary for the user to have an apparatus comprising a specific program for recognizing his own language, in order to convert said language into text.

This also means that the producer of the apparatus is not able to produce a single product that can be sold in different countries, where the users speak different languages. The consequence of that are an increased number of models for the same product and an increase of cost of production

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the FPO (Article 83 of the EPC), such that applicant(s) reserve the right to disclaim, and hereby disclose a disclaimer of, any previously described product, method of making the product, or process of using the product.

### SUMMARY OF THE INVENTION

In this frame, it is the main object of the present invention to overcome the above-mentioned drawbacks by providing an apparatus and a method for image data recording and reproducing which allow to recognize and convert into text a plurality of languages.

It is a further object of the present invention to provide an apparatus and a method for image data recording and reproducing conceived in a manner to be versatile and eclectic.

It is a further object of the present invention to provide a single apparatus and method for image data recording and reproducing able to recognize and convert into text a plurality of different languages.

These objects are achieved by the present invention through an apparatus and a method for image data recording and reproducing, incorporating the features set out in the appended claims, which are intended as an integral part of the present description.

Further objects, features and advantages of the present invention will become apparent from the following detailed description and from the annexed drawings, which are supplied by way of non-limiting example, wherein:

### BRIEF DESCRIPTION OF THE DRAWINGS

FIG. 1 is a block diagram of an apparatus for image data recording and reproducing, in particular a digital camera, according to the present invention;

FIG. 2 is a block diagram illustrating a first embodiment of a method for image data recording and reproducing according to the present invention; and

FIG. 3 is a block diagram illustrating a second embodiment of a method for image data recording and reproducing according to the present invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

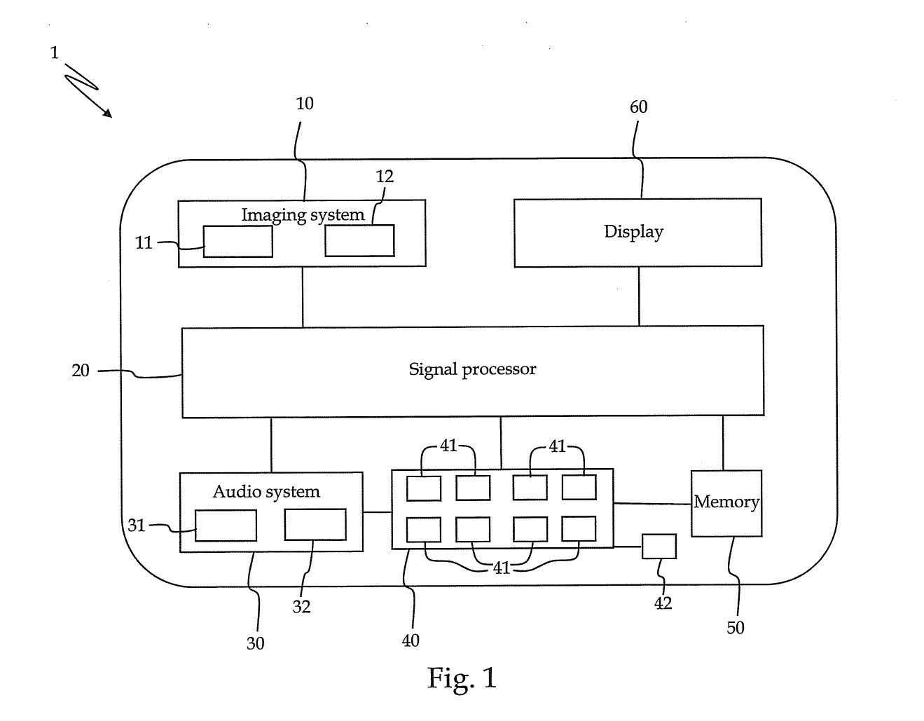

In FIG. 1, reference numeral 1 designates as a whole an apparatus for image data recording and reproducing, according to the present invention.

The apparatus 1 for image data recording and reproducing according to the exemplary embodiment of the present invention may be a digital still camera, a digital video camera, a mobile telephone having an integrated or associated digital camera, and the like.

Said apparatus 1 comprises:
an imaging system 10 for capturing an image;
a signal processor 20 coupled to said imaging system 10 for processing the captured image as a digital image file;
an audio system 30 coupled to said signal processor 20 for acquiring at least one speech annotation apt to be associated with said digital image file;
a speech recognition unit 40 for recognizing said at least one speech annotation and converting the speech annotation into text data, said speech recognition unit 40 being associated to the signal processor 20 for generating metadata using the text data and adding the generated metadata to the digital image file.

Said imaging system 10 may comprise a lens/shutter assembly 11, which directs and focuses light onto a sensor 12 for capturing images of a subject; in particular, said sensor 12 can comprise one or more CCD (Charge Coupled Device) or one or more CMOS (Complementary Metal-Oxide Semiconductor).

Therefore, said signal processor 20 controls the operations of the lens/shutter assembly 11 and processes image information received from the sensor 12 for generating an image file containing the captured image in a digital format.

When the image file includes still image data, the digital image file may be in Joint Photographic Experts Group (JPEG) or Tag Image File Format (TIFF) format; when the image file includes moving image data, the digital image file may be in Moving Picture Experts Group (MPEG) format or other video formats known on the state of the art.

Moreover, as known at the state of the art, each of the image files includes an area for storing the image data and an area for storing information regarding the image. This is done in accordance to international standards. In fact there are some entities that have defined how to add metadata to image files, like:
IPTC Information Interchange Model IIM (International Press Telecommunications Council),
IPTC Core Schema for XMP, •XMP—Extensible Metadata Platform (an Adobe standard),
EXIF—Exchangeable image file format, Maintained by CIPA (Camera & Imaging Products Association) and published by JEITA (Japan Electronics and Information Technology Industries Association),
Dublin Core (Dublin Core Metadata Initiative—DCMI),
PLUS (Picture Licensing Universal System).

As it can be seen from FIG. 1, the audio system 30 preferably comprises a microphone 31 for allowing a user to record a short audio or voice annotation, record sound for digital video recording, input voice commands, and the like. Said audio system 30 may also comprise a speaker 32.

In accordance with the present invention, said speech recognition unit 40 comprises a plurality of subsets 41 of words, each subset 41 having a limited number of words, in order to recognize and convert into text speech annotations acquired from a corresponding plurality of languages.

In particular, each subset 41 of words does not comprise a complete dictionary of words of a specific language, but each subset 41 of words comprises a relative translation in a determined language only of a limited number of words, choosing and memorizing them at the manufacturer site only between the words more frequently used for being associated to a determined image.

In particular, said plurality of words may comprise:
terms indicating a celebration and/or a recurrence and/or a festivity (such as, for example: “Party”, “Holiday”, “Baptism”, “Marriage”, “Birthday”, “Christmas”, “Easter”, etc.);
terms indicating a geographic place (such as, for example: “Sea”, “Desert”, “Hill”, “Mountain”, “Lake”, etc.);
terms indicating countries all around the world (such as “Germany”, “France”, “Italy”, “The United States of America”, “Japan”, “China”, “Korea” etc.) and the major cities in these countries (such as “Frankfurt”, “Munich”, “Paris”, “Rome”, “Los Angeles”, “Las Vegas”, “Tokyo” “Shanghai”, “Hong Kong”, “Macau”, “Seoul”), as well as famous buildings and pieces of fine art in these cities (such as “Chinese Wall”, “Casino”, “Coliseum”, “Tour Eiffel”, etc.;
terms indicating a season (such as: “Spring”, “Summer”, “Autumn”, “Winter”) and/or a month and/or a day of the week;
terms indicating a number, in particular numbers from zero to nine in order to be able to compose each number;
terms indicating a relationship with a person (such as, for example: “Brother”, “Sister”, “Father”, “Mother”, “Grandfather”, “Grandmother”, “Uncle”, “Aunt”, “Cousin”, “Friend”, “Husband”, “Wife”); terms indicating the name of a person (such as, for example: “Carl”, “Paul”, “Peter”, “John”, “Frank”, “Robert”, “Abbie”, “Jane”, “Mary”, “Beth”);
terms indicating an animal (such as, for example: “Dog”, “Cat”, “Horse”, “Bird”) and/or a thing (such as, for example: “House”, “Office”, “Garden”, “Church”, “Cathedral”, “Car”, “Bike”).

This provision allows to obtain an apparatus and a method for image data recording and reproducing which allow to recognize and convert into text a plurality of languages, even if limited to a subset of words.

It is clear that if the word that the user wants to associate to a certain image is not provided by the limited subset of words memorized and recognizable by the apparatus, this particular word can be edited manually by making use of one of the several tools known in the state of the art for writing words: keyboards, touch screen systems, etc.

In particular, the apparatus 1 and the method according to the present invention allows to recognize speech and to convert the speech into text data without the need of using a speech recognition unit 40 expensive, large and very big in size, usually in the order of many megabyte (or a gigabyte), for each language that has to be recognized and converted into text. Therefore, this solution can be implemented in consumer products like digital still cameras, digital video cameras, mobile telephones having integrated digital cameras, and the like, without charging these products with a cost that cannot accepted by the market.

It is therefore clear that said speech recognition unit 40 can be utilized in the apparatus 1 without making a choice at the manufacturer site of a predetermined language to be used, and that said speech recognition unit 40 allows to indicate one single apparatus 1 and method conceived in such a manner to be extremely versatile and eclectic.

Preferably, said speech recognition unit 40 is associated to activating means 42 that allow the user to activate the speech recognition unit 40 in order to convert the speech annotation into text data.

In particular, said activating means 42 can be actuated by the user before the image is captured and/or displayed; otherwise, said activating means 42 can be actuated by the user after the image is captured, in particular when said image is displayed. For example, said activating means 42 may comprise a button (not shown in the drawings) preferably positioned on an external surface of the apparatus 1.

The apparatus 1 comprises also a memory 50 coupled to the signal processor for storing the digital image file and/or the speech annotation and/or the speech annotation converted into text data. Said memory 50 can comprise a Random Access Memory (RAM), a Read Only Memory (ROM), an Electrically Erasable Programmable Read Only Memory (EEPROM), or the like.

Moreover, the apparatus 1 further comprises a display 60 associated to the signal processor 20. As known, said display 60 can be used for a plurality of purposes, in particular:
for displaying the image to be captured to the user; in this case the display 60 allows the user to center and focus the image, pose persons appearing in the image, and the like;
for displaying a captured image, stored in the memory 50 as a digital image files;
for displaying menus apt to convey information to the user,
for selecting features of the apparatus 1;
for controlling operation of the apparatus 1, and the like.

In a preferred embodiment of the present invention, said display 60 comprises an On Screen Display (OSD) system apt to choose both a language between a plurality of languages for displaying the operation of the apparatus 1, both one of said subsets 41 of words.

As said before, it is clear that the apparatus 1 can comprise input means (not shown in FIG. 1) for generating metadata in a traditional manner and in accordance to international standards, i.e. producing text data for generating metadata to be added to the digital image file; for example, said input means may comprise a keyboard or a touch screen.

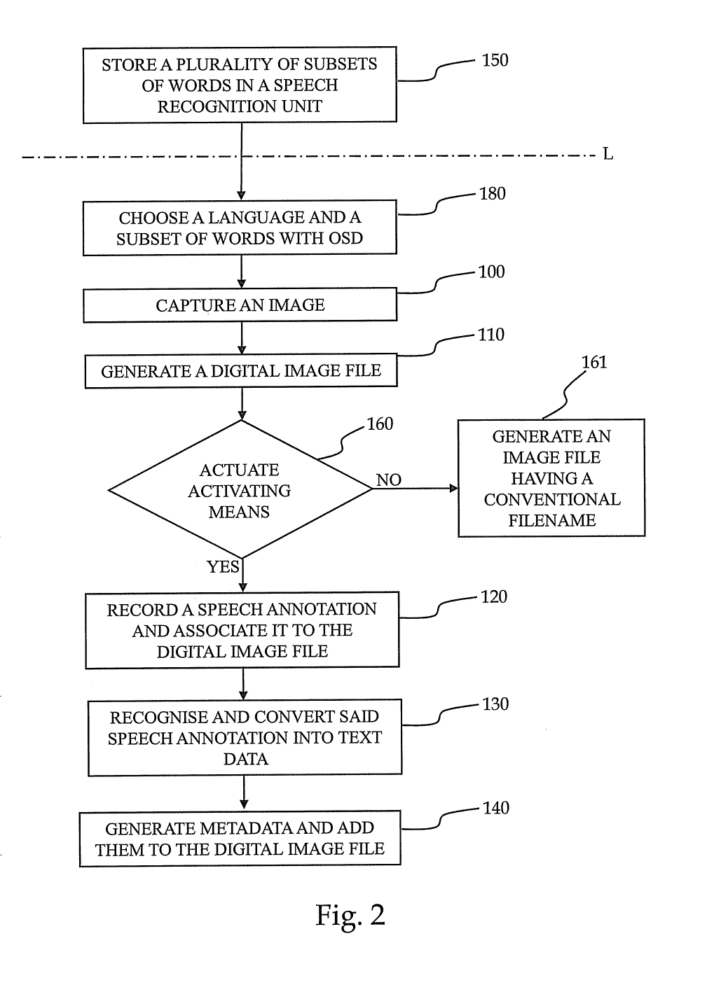

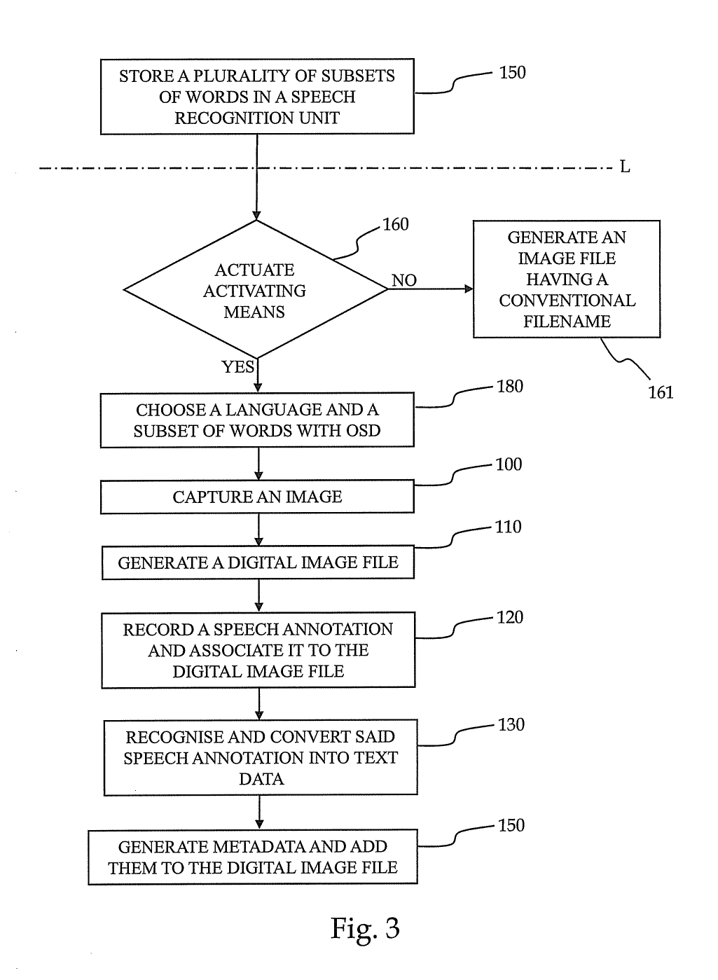

FIGS. 2 and 3 respectively relate to a first and to a second representation of a method for image data recording and reproducing according to the present invention.

In particular, said method comprises the following steps:
storing (step 150) at the manufacturer site a plurality of subsets 41 of a limited number of words in said speech recognition unit 40 for recognising and converting into text speech annotations acquired from a corresponding plurality of languages;
capturing an image by means of an apparatus 1 comprising an imaging system 1 (step 100);
processing the captured image as a digital image file through a signal processor 20 coupled to said imaging system 10 (step 110);
recording at least one speech annotation, in particular in a memory 50, by means of an audio system 30 coupled to said signal processor 20, said at least one speech annotation being apt to be associated with said digital image file (step 120);
recognising said at least one speech annotation and converting the speech annotation into text data by means of a speech recognition unit 40 associated to the signal processor 20 (step 130);
generating metadata using the text data and adding the generated metadata to the digital image file (step 140).

According to the present invention, said step 130 of recognising and converting the speech annotation into text data is performed by making use of one of the plurality of subsets 41 of words stored in said speech recognition unit 40 for recognising and converting into text speech annotations acquired from a corresponding plurality of languages.

In FIGS. 2 and 3, the line L indicates the fact that said step 150 of storing a plurality of subsets 41 of a limited number of words in said speech recognition unit is accomplished at the manufacturer site.

In particular, the method according to the present invention is performed through the step 160 of actuating activating means 42 of the speech recognition unit 40, said activating means 42 allowing the user to activate the speech recognition unit 40 in order to convert the speech annotation into text data.

As can be seen in particular in FIG. 2, said step 160 of actuating said activating means 42 can be performed after the step 110 of processing the captured image, i.e. when said image is already recorded in a memory 50 of the apparatus 1. In this case, said step 160 can be preceded by a step 161 of generating an image file having a conventional filename. Moreover, in the case the user decides not to actuate said activating means 42, the apparatus 1 can perform the step 161 of generating an image file having a conventional filename.

Alternatively, as can be appreciated in particular from FIG. 3, said step 160 of actuating said activating means 42 can be performed before said step 100 of capturing an image.

Moreover, the method according to the present invention comprises the further step 180 of choosing both a language between a plurality of languages for displaying the operation of the apparatus 1, both one of said subsets 41 of words by means of an On Screen Display (OSD) system comprised in said display 60.

Preferably, with reference to the method of FIG. 2, said step 180 of choosing a language and a subset of words is performed before the step 100 of capturing an image; with reference to the method of FIG. 3, said step 180 of choosing a language and a subset of words is performed after the step 160 of actuating said activating means 42.

Moreover, it must be noticed that the present invention can also be embodied as computer readable metadata on a computer readable storage medium/data. The computer readable storage medium/data is any data storage device that can store data, which can be thereafter read by a computer system. Examples of the computer readable recording medium include Electrically Erasable Programmable Read Only Memory (EEPROM), random-access memory (RAM), CD-ROMs, magnetic tapes, floppy disks, optical data storage devices, and the like.

The advantages offered by an apparatus and a method for image data recording and reproducing according to the present invention are apparent from the above description.

In particular, such advantages are due to the fact that the provision of a speech recognition unit 40 comprising a plurality of subsets 41 of words allows to recognize and convert into text a plurality of languages; in particular, this can be done without the need of using a speech recognition unit 40 expensive, large and very big in size, usually in the order of many megabyte (or a gigabyte), for each language that has to be recognized and converted into text.

It is therefore clear that clear that said speech recognition unit 40 can be utilized in the apparatus 1 without making a choice of a predetermined language that has to be recognized and converted into text, therefore, the particular realization of the speech recognition unit 40 according to the present invention allows to indicate an apparatus 1 and a method conceived in such a manner to be versatile and eclectic.

The apparatus and method described herein by way of example may be subject to many possible variations without departing from the novelty spirit of the inventive idea; it is also clear that in the practical implementation of the invention the illustrated details may have different devices or be replaced with other technically equivalent elements, as well as providing different sequences of steps.

For instance with respect to the embodiments shown in FIGS. 2 and 3, the step 180 of choosing the language can be followed immediately from the step 160 of actuating the activating means, making it manually be the user or automatically by the apparatus 1, as the consequence of having chosen both the language for displaying the operation of the apparatus 1 and one of said subsets 41 of words.

It can therefore be easily understood that the present invention is not limited to the above-described apparatus and method, but may be subject to many modifications, improvements or replacements of equivalent parts and elements without departing from the inventive idea, as clearly specified in the following claims.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. An apparatus for image data recording and reproducing, said apparatus comprising:
an imaging system for capturing an image;
a signal processor coupled to said imaging system for processing the captured image as a digital image file;
an audio system coupled to said signal processor for acquiring at least one speech annotation apt to be associated with said digital image file;
a speech recognition unit for recognizing said at least one speech annotation and converting the speech annotation into text data, said speech recognition unit being associated to the signal processor for generating metadata using the text data and adding the generated metadata to the digital image file;
wherein said speech recognition unit comprises a plurality of subsets of words, each subset having a limited number of words, in order to recognize and convert into text speech annotations acquired from a corresponding plurality of languages.

2. The apparatus according to claim 1;
wherein each subset of words comprises a relative translation in a determined language only of a limited number of words, choosing and memorizing them at the manufacturer site only between the words more frequently used for being associated to a determined image.

3. The apparatus according to claim 1;
wherein said speech recognition unit is associated with activating means that allow the user to activate the speech recognition unit in order to convert the speech annotation into text data.

4. The apparatus according to claim 1;
wherein said apparatus comprises a memory coupled to the signal processor configured to store at least one of the digital image file, the speech annotation, and the speech annotation converted into text data.

5. The apparatus according to claim 1;
wherein said apparatus comprises a display associated with the signal processor.

6. The apparatus according to claim 5;
wherein said display comprises an On Screen Display (OSD) system apt to choose both a language between a plurality of languages for displaying the operation of the apparatus, and one of said subsets of a limited number of words.

7. The apparatus according to claim 1;
wherein said apparatus comprises input means for generating metadata using said text data and coding them according to a determined international standard.

8. A method for image data recording and reproducing comprising the following steps:
capturing an image by means of an apparatus comprising an imaging system;
processing the captured image as a digital image file through a signal processor coupled to said imaging system;
recording at least one speech annotation, in particular in a memory, by means of an audio system coupled to said signal processor, said speech annotation being apt to be associated with said digital image file;
recognising said speech annotation and converting at least one speech annotation into text data by means of a speech recognition unit associated to the signal processor;
generating metadata using the text data and adding the generated metadata to the digital image file;
wherein said step of recognising and converting the at least one speech annotation into text data is performed by means of a step of storing at a manufacturer site a plurality of subsets of a limited number of words in said speech recognition unit and using the subsets of words for recognising and converting into text the speech annotations acquired from a corresponding plurality of languages.

9. The method according to claim 8, further comprising:
a step of actuating activating means of the speech recognition unit, said activating means allowing the user to activate the speech recognition unit in order to convert the speech annotation into text data.

10. The method according to claim 9;
wherein said step of actuating said activating means is performed after the step of processing the captured image.

11. The method according to claim 9;
wherein said step of actuating said activating means is performed before said step of capturing an image.

12. The method according to claim 11;
wherein said step of actuating said activating means is preceded by a step of generating an image file having a conventional filename.

13. The method according to claim 8, further comprising:
a step of choosing both a language between a plurality of languages for displaying the operation of the apparatus, and one of said subsets of a limited number of words by means of an On Screen Display (OSD) system comprised in said display.

14. The method according to claim 13;
wherein said step of choosing a language and a subset of a limited number of words is performed before said step of capturing an image.

15. The method according to claim 13;
wherein said step of choosing a language and a subset of words is performed after said step of actuating said activating means.

16. A non-volatile information recording medium which is readable by a computer, comprising:
a computer program recorded on the information recording medium;
wherein the computer program includes instructions which cause the computer to implement the method of claim 8

17. A computer coupled to the non-volatile information recording medium of claim 16.
